(19) United States
(12) Patent Application Publication
(10) Pub. No.: US 2012/0328916 A1
(43) Pub. Date: Dec. 27, 2012

(54) BATTERY FOR A MOTOR VEHICLE

(75) Inventor: Norbert Enning, Denkendorf (DE)

(73) Assignee: AUDI AG, Ingolstadt (DE)

(21) Appl. No.: 13/581,771

(22) PCT Filed: Feb. 3, 2011
(86) PCT No.: PCT/EP2011/000495

§ 371 Date: Aug. 29, 2012

(30) Foreign Application Priority Data
Mar. 1, 2010 (DE) 10 2010 009 732.2

(51) Int. Cl. H01M 10/50

(52) U.S. Cl. 429/72

(57) ABSTRACT

A battery for a motor vehicle includes a battery housing in which at least one cell group having a plurality of electrochemical cells is accommodated, wherein the cells of a cell group are held on a respective cell carrier, wherein a cover part of the cell carrier includes a coolant conduit for cooling the cells of the cell group. The cell carrier thus combines a holding function and a cooling function, and for this reason such a battery has a particularly simple design and is particularly lightweight. Good heat dissipation is ensured by the large surface area of the cover part.

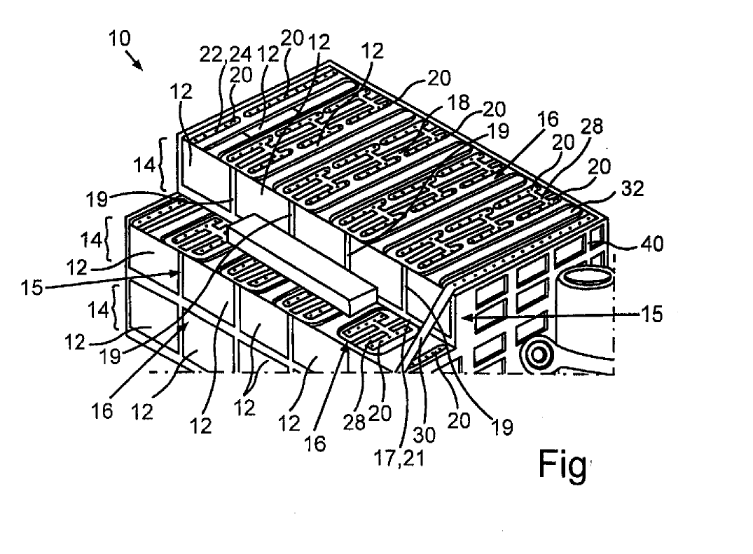

The invention relates to a battery for a motor vehicle.

In order to supply the drive aggregates of electric or hybrid vehicles with energy high voltage batteries with high power density are used. In order to achieve the high terminal voltage a plurality of individual electro chemical cells is connected in series in such batteries so that the relatively low terminal voltages of the individual cells add up to the desired overall terminal voltage of the battery. Due to the high charge and discharge capacity when operating such batteries the individual electrochemical cells strongly heat up when charging or discharging the battery. Such batteries therefore have to be cooled to avoid overheating.

From DE 10 2005 047 034 A1 a device for cooling of batteries of a vehicle is known, in which the individual cells of a battery are received in a housing and are circulated with air by means of a fan. Due to the relatively low heat capacity of air such a cooling device has to have a high powered and therefore, heavy fan in order to ensure the desired heat dissipation.

From DE 10 2006 004 419 A1 a further cooling device is known in which a plate shaped cooling element is arranged between two respective individual cells of a battery, which individual cells are circulated by coolant. Such devices offer a good cooling capacity however, they are heavy and their construction involves high effort.

The present invention is thus based on the object to provide a battery for a motor vehicle which battery can be cooled well and at the same time has a low own weight and a simple design.

This object is solved by a battery with the features of patent claim 1.

This battery for a motor vehicle has a battery housing in which at least one cell group having a plurality of electrochemical cells is received. The cells of a cell group are held in a respective cell carrier, wherein a cover part of the cell carrier includes a coolant conduit for cooling the cells of the cell groups. The cell carriers of such a battery have thus two functions. On one hand they hold the individual cells in their desired position and on the other hand heat can be dissipated from the electrochemical cells of the battery by the coolant conduits which are integrated in the cover part. This functional integration creates a particularly light battery.

Because the electrochemical cells are held directly on the cell carrier, a direct contact is given so that heat can be dissipated from the electrochemical cells directly to the coolant conduit by thermal conduction and with this also to a coolant which flows through the coolant conduit. This allows a particularly favorable heat dissipation from the battery.

In a preferred embodiment of the invention the cells are connected to the cover part on the side of their tapping poles. Because on the side of the tapping pole the current density in the electrodes of one cell is particularly high, particularly large amounts of heat accrue at this location. Such an arrangement thus conducts heat way exactly from the thermally stressed regions of the cell.

In a further embodiment of the invention an air gap is present between each two neighboring cells of a cell group. The air gap allows on one hand heat dissipation by convection so that heat which accrues in regions of he cells which are not in direct contact with the cell carrier can be dissipated as well. At the same time however, such an air gap also allows a certain thermal insulation between neighboring cells because due to the low heat conductivity of air, neighboring cells barely heat up one another when such an air gap is present.

An air gap can also be present between the cells of a cell group and the cover part. In this case the cover part touches only regions of the cells, for example directly at their tapping poles, which still provides a sufficient thermal contact. Through the air gap heat can also be transported by convection in this case and transferred to the cell carriers. In addition, the air gaps provide space for the thermal expansion between the individual cells so that tension between individual cells and their contact elements is avoided when the battery heats up.

Preferably the battery housing is sealed air tight. This prevents that in case of a defect of one cell an electrolyte is released into the environment. The air in an optionally present small air volume of the battery housing normally does not have to be moved by means of fans or the like because due to the high heat dissipation capacity of the cell carriers the convection in the air space is sufficient for heat distribution.

In order to achieve a particularly good heat distribution inside the battery housing, according to a further preferred embodiment of the invention at least one fan can nevertheless be provided for circulating air within the battery housing. Such a fan serves for supporting the convection-driven heat distribution within the battery housing. Because the actual heat dissipation occurs via the cooling means ducts, such a fan can be dimensioned particularly small and lightweight.

Preferably the battery has at least two cell groups which in a mounting position of the battery are arranged vertically on top of one another. One respective cover part of a respective cell carrier is arranged between the cell groups. Such a battery is thus constructed in a modular fashion and is formed by stacking of cell groups on top of one another which cell groups are each connected to one associated cell carrier. Because each cell carrier has cooling ducts, such a battery is cooled particularly well across its entire volume.

Preferably the coolant conduit extends serpentine-like through the cover part. This provides a particularly great contact surface area between the cell carrier itself and the coolant which flows though the coolant conduit so that a particularly good cooling capacity is achieved. Here, it is particularly useful to integrate the coolant conduit by casting in a plastic base body of the cover part.

Preferably the coolant conduits of all cover parts of the battery are connected with a common coolant connection of the battery housing. This allows for a particularly easy mounting of the battery because only one coolant supply conduit and one coolant discharge conduit have to be connected to the battery so that optionally, batteries with different numbers of cell groups can be connected to otherwise identical components of a cooling system.

The invention further relates to a motor vehicle with a battery of the described type.

In the following, the invention and its embodiments are explained in more detail by way of the drawing. The sole FIGURE shows a perspective view of an embodiment of a battery according to the invention.

A high voltage battery designated overall with 10 is formed by a plurality of individual lithium ion cells 12, which for reasons of simplicity are not all indicated in the FIGURE. In order to achieve the desired terminal voltage of several hundred volts, the lithium ion cells 12 are connected in series.

The individual cells 12 are combined to cell groups 14 and held by respective common carriers 15. The carriers 15 are formed by a base frame 17 and a cover plate 16. Webs which project from the bottom 21 of the base frame 17 delimit receptacles for the individual cells 12. The cover plate 16 has a plastic base body 18 with serpentine coolant conduits 32 which extend over the entire surface of the cover plate 16. During operation of the battery 10, a coolant circulates in the coolant conduits 32 in order to dissipate the heat which accrues in the individual cells 12. Expediently, the coolant conduits 32 are cast into the cover plate 16.

The arrangement of the coolant conduits 32 in the cover plates 16 which are placed on individual cells on the side of the tapping poles 24 of the individual cells 12 is particularly useful, because especially high amounts of heat accrue in the direct vicinity of the tapping poles 24. In order to dissipate heat also from other regions of the individual cells, an air gap 34 is provided between neighboring individual cells 12. An air gap 38 is also provided between a front surface 36 of the individual cells and the cover plate 16. Through the air gaps 34, 38 heat can additionally be dissipated from the individual cells by convection. The air gaps do not serve for the actual heat dissipation from the battery 10 which occurs via the coolant conduits but rather for the even distribution of heat inside the battery 10. Optionally, the heat distribution by convection can further be supported by a fan which is not shown.

The individual cell groups 14 are housed in a housing 40 and can be fastened to vehicle body components of the motor vehicle. Between the individual cell groups 14 no further mechanical connections are required; they can easily be stacked on top of one another inside the housing 40, which allows for a particularly easy production of the battery 10. The housing 40 is expediently liquid tight and air tight so that in case of leaking of a cell 12 no electrolyte can be released into the environment.

Electric contact elements 20, which are also not all indicated in the FIGURE, are cast into the cover plates 16. The contact elements 20 have openings 22 into which connection poles 24 of the individual cells 12 are inserted. The openings of the contact elements 20 have an insertion slant which facilitates the insertion of the connection poles 24.

In order to join a cell group 14, the individual cells 12 of the cell group therefore only have to be pre-oriented roughly in the base frame 17 of the cell carrier 15. When putting on the cover plate 16, the individual cells 12 are automatically correctly oriented by the interaction between the tapping poles 24 and the insertion slant of the contact elements 20. This allows for a particularly good automation of the manufacture of such a battery 10.

The contact elements 22 which contact neighboring individual cells 12 are interconnect in an electrically conducting manner via bridges 28, resulting in a connection in series of the individual cells in the cell groups 14. By further connection elements 30 the individual cell groups 14 are again connected to one another in series so that in spite of the low terminal voltage of customary individual cells, for example 1.7 V in lithium ion cells, an overall voltage of the battery of several hundred volts can be achieved.

Further elements of the battery 10 can be integrated into the cover plate 16. For example, it is possible to cast a control device into the plastic base body 18 of the cover plate 16 which control device allows balancing the state of charge of the individual cells 12 when charging or discharging the battery, which significantly enhances the service life of such batteries. Each cover plate 16 together with the associated cells 12 and the base frame 17 of the cell carrier thus forms a module which provides all functions necessary for operating the cells 12. Differently dimensioned batteries 10 can be constructed most easily from the individual modules.

What is claimed is:

1.-10. (canceled)

11. A Battery for a motor vehicle, comprising:
a battery housing;
at least one cell group received in the battery housing and comprising a plurality of electrochemical cells; and
a cell carrier having a plate-shaped cover part, said plate shaped cover part comprising a coolant conduit for cooling the cells of the at least one cell group, wherein the cells of the at least one cell group are held on the cell carrier.

12. The battery of claim 11, wherein the cells are connected with the cover part on a side of tapping poles of the cells.

13. The battery of 11, wherein an air gap is provided between respective neighboring ones of the cells.

14. The battery of claim 11, wherein an air gap is provided between the cells of the cell group and the cover plate.

15. The battery of claim 11, wherein the battery housing is sealed air tight.

16. The battery of claim 11, further comprising at least one fan for circulating air inside the battery housing.

17. The battery of claim 11, further comprising at least two of said at least one cell group, wherein in a mounting position of the battery said at least two cell groups are arranged vertically atop of one another, and are separated from one another by the cover part.

18. The battery of claim 11, wherein the coolant conduit extends in a serpentine manner through the cover part.

19. The battery of claim 11, further comprising multiple of said cell carrier, wherein the coolant conduit of the cover part of each cell carrier is connected with a common coolant connection of the battery housing.

20. A motor vehicle, comprising:
a battery which comprises a battery housing, at least one cell group received in the battery housing and comprising a plurality of electrochemical cells, and a cell carrier having a plate-shaped cover part and comprising a coolant conduit for cooling the cells of the cell group, wherein the cells are held on the carrier.
